(19) United States
(12) Patent Application Publication
(10) Pub. No.: US 2026/0326205 A1
(43) Pub. Date: Oct. 22, 2026

(54) MANUFACTURING METHOD OF HIGH-STRENGTH COMPONENT HAVING EXCELLENT HYDROGEN EMBRITTLEMENT RESISTANCE

(71) Applicant: MITSUCHI CORPORATION, Kasugai-shi (JP)

(72) Inventors: Gosuke AIMONO, Kasugai-shi (JP); Masashi NAKAMURA, Kasugai-shi (JP); Yuhei OGAWA, Kasugai-shi (JP); Hisao MATSUNAGA, Kasugai-shi (JP)

(73) Assignee: MITSUCHI CORPORATION, Kasugai-shi (JP)

(21) Appl. No.: 19/120,374

(22) PCT Filed: Oct. 12, 2023
(86) PCT No.: PCT/JP2023/037009

§ 371 Date: Apr. 11, 2025

(30) Foreign Application Priority Data
Oct. 14, 2022 (JP) 2022-165794

(51) Int. Cl. B22F 10/28; B22F 10/36; B22F 10/64; B22F 10/80; B33Y 10/00; B33Y 50/00; B33Y 70/00; B33Y 80/00; C22C 38/02; C22C 38/04; C22C 38/06; C22C 38/44; C22C 38/46; C22C 38/50; C22C 38/54

(52) U.S. Cl. CPC B22F 10/28; B22F 10/36; B22F 10/64; B22F 10/80; C22C 38/02; C22C 38/04; C22C 38/06; C22C 38/44; C22C 38/46; C22C 38/50; C22C 38/54; B22F 2301/35; B33Y 10/00; B33Y 50/00; B33Y 70/00; B33Y 80/00

(57) ABSTRACT

A manufacturing method of a high-strength component having excellent hydrogen embrittlement resistance comprises: modeling an additively manufactured object having a volume density of 99.9% or more by a three-dimensional additive manufacturing method using a laser or an electron beam having an energy density of 60 J/mm³ or more using a metal powder having a composition containing, by weight percentage (wt %): C: 0.010% to 0.025%, Si: 0.15% or less, Mn: 0.15% or less, P: 0.01% or less, S: 0.01% or less, Ni: 24% to 27%, Cr: 13.5% to 16%, Mo: 1% to 1.5%, V: 0.10% to 0.50%, Al: 0.35% or less, Ti: 1.90% to 2.35%, and B: 0.0006% to 0.0020%; and manufacturing the high-strength component by finishing the additively manufactured object.

### TECHNICAL FIELD

The art disclosed herein relates to a manufacturing method of a high-strength component. More specifically, it relates to a method for producing a manufacturing method of a high-strength component having excellent hydrogen embrittlement resistance.

### BACKGROUND ART

As a next-generation energy infrastructure, systems such as fuel cells that utilize hydrogen as an energy medium are being developed. Hydrogen pipe components used in such systems, especially pipe joints, are exposed to high-pressure or liquefied hydrogen, and thus must be made of high-strength steel and must resist “hydrogen embrittlement of metal”, which is a phenomenon unique to hydrogen.

Non-Patent Document 1 (Akira Saito, Toshio Tezuka, Yoshiaki Aikawa, Kazunori Kawamata, “Research and Development on Technical Standards for Hydrogen Infrastructure (Steel Grade Expansion)”, 2019) states that steel materials containing components with a stable austenite structure are suitable, and as a composition index thereof, a nickel equivalent of 28.5 or more is defined as a guideline for material selection and material development. Among existing steel materials that satisfy this composition index, SUH660 specified in JIS G4311 is a steel material with a high nickel equivalent and high strength, and application of SUH660 in hydrogen pipe components, especially in high-pressure pipe joints (connectors), is being considered.

However, when such components are manufactured, for example, by performing full cuts on a wrought material, machining efficiency is significantly decreased due to poor machinability of components that increase the nickel equivalent (Ni, Cr, etc.), and further, this results in a decrease in quality of cut shapes and surface roughness. Further, for the purpose of reducing cutting allowances, a manufacturing method that manufactures a net-shape blank by forging may be considered, however, since the above components undergo significant work hardening during the forging, it is difficult to manufacture components with a shape that has large steps. Furthermore, accuracy of cutting with a large cutting allowance and accuracy of forging with a large machining deformation are highly dependent on operator's experience and skills. As such, variations in production efficiency and quality tend to occur.

On the other hand, as described in Non-Patent Document 2 (Yuichiro Koizumi, Akihiko Chiba, Naoyuki Nomura, and Takayoshi Nakano, “Fundamentals of 3D Additive Manufacturing Technology for Metallic Materials” 2017), technologies that produces objects with various shapes by a three-dimensional metallic additive manufacturing method using various metal powders have recently been developed. This enables formation of objects with relatively complex shapes, and enables to design an object with shapes close to its final finished shape and reduce its cutting allowance. Due to this, freedom of design is increased.

### SUMMARY OF INVENTION

### Technical Problem

Recently, there have been technological progresses to manufacture high-strength components such as hydrogen pipe components using the three-dimensional additive manufacturing method. However, depending on a metal powder composition, pores that remain inside an object during modeling and microcracks at grain boundaries (hereinafter referred to as “microcracks”) can easily occur. Due to this, strength and hydrogen embrittlement resistance are still not at their required levels compared to conventional steel materials containing the same composition (e.g., wrought bar materials). That is, due to material composition factors, there is a problem that no matter how laser or other irradiation conditions are changed, it is not possible to sufficiently reduce modeling defects. In particular, although SUH660, a widely used material, is used for manufacturing high-strength components as a high-strength material with hydrogen embrittlement resistance in the form of wrought bar materials, the aforementioned microcracks occur prominently in the three-dimensional additively manufactured objects. The description herein provides an art configured to manufacture a high-strength component with high strength and excellent hydrogen embrittlement resistance by a three-dimensional additive manufacturing method using metal powder having an aforementioned composition.

### Solution to Technical Problem

The inventors have studied additively manufactured objects made by three-dimensional additive manufacturing methods, and have found that when a molten layer solidifies and when a layer layered below the molten layer is re-heated by the molten layer, liquefaction cracking or cracking by loss in ductility, i.e., microcracks, along a grain boundary occurs due to segregation of specific components at the grain boundary. Further, as a result of experimental attempts, the inventors found that an additively manufactured object can be endowed high strength and excellent hydrogen embrittlement resistance by using a metal powder with a specific composition adjusted to a specific value within a range of steel specifications specified in JIS G4311.

A manufacturing method of a high-strength component having excellent hydrogen embrittlement resistance disclosed herein may comprise: modeling an additively manufactured object having a volume density of 99.9% or more by a three-dimensional additive manufacturing method using a laser or an electron beam having an energy density of 60 J/mm³ or more using a metal powder having a composition containing, by weight percentage (wt %): C: 0.010% to 0.025%, Si: 0.15% or less, Mn: 0.15% or less, P: 0.01% or less, S: 0.01% or less, Ni: 24% to 27%, Cr: 13.5% to 16%, Mo: 1% to 1.5%, V: 0.10% to 0.50%, Al: 0.35% or less, Ti: 1.90% to 2.35%, B: 0.0006% to 0.0020%, and the balance consisting of Fe and unavoidable impurities; and manufacturing the high-strength component by finishing the additively manufactured object.

In the above manufacturing method, the additively manufactured object is modeled by the three-dimensional additive manufacturing method using the metal powder having the above composition. In this manufacturing method, the metal powder is completely melted and layered by the laser or electron beam with the energy density of 60 J/mm³ or more, so that the volume density of the manufactured object is 99.9% or more. This additively manufactured object has very low levels of pores remaining inside the object and microcracks at grain boundaries from manufacturing processes. Thus, by finishing the additively manufactured object, a high-strength component with high strength and excellent hydrogen embrittlement resistance can be obtained.

### BRIEF DESCRIPTION OF DRAWINGS

FIG. 1 a side view of an additively manufactured object 10.

FIG. 2 atop view of the additively manufactured object 10.

FIG. 3 a cross-sectional view of the additively manufactured object 10.

FIG. 4 a side view of a pipe connector 30.

FIG. 5 atop view of the pipe connector 30.

FIG. 6 a cross-sectional view of the pipe connector 30.

FIG. 7 a plurality of additively manufactured objects 10 modeled on a modeling plate 50.

FIG. 8 a side view of a shape of a test piece.

FIG. 9 a graph showing stress-strain curves of each test piece before performing a hydrogen charge.

FIG. 10 scanning electron micrograph (SEM) images showing a fracture surface of each test piece before the hydrogen charge.

FIG. 11 a graph showing stress-strain curves of each test piece after the hydrogen charge.

FIG. 12 SEM images showing the fracture surface of each test piece after the hydrogen charge.

### DESCRIPTION OF EMBODIMENTS

Main features of embodiments described below are listed below. The technical elements described below are independent technical elements that demonstrate their technical usefulness alone or in various combinations, and are not limited to the combinations described in the claims at the time of filing.

In an aspect of the present teachings, the manufacturing method may further comprise: performing a solution heat treatment in which the additively manufactured object is kept at 885 to 915° C. or 965 to 995° C. for 10 minutes to 2 hours, and then rapidly cooled to room temperature; and performing an aging treatment in which the additively manufactured object is kept at 680 to 700° C. for 16 hours or more, and then air-cooled to room temperature, after performing the solution heat treatment. The solution heat treatment may be performed on the additively manufactured object that has been modeled or on the additively manufactured object that has been finished. Further, the aging treatment may be performed at any timing after the solution heat treatment. That is, the aging treatment may be performed after the modeled additively manufactured object is subjected to the solution heat treatment and the finishing.

In such a configuration, Vickers hardness of the additively manufactured object can be 300 HV or more by the above solution heat treatment and aging treatment. Due to this, strength of the manufactured high-strength component can be ensured. As a result, the manufactured high-strength component (e.g., high-pressure hydrogen pipe component) can increase a contact surface pressure between itself and an object structure to be contacted or secured. Due to this, high-pressure hydrogen or liquid hydrogen can thereby be sealed, and leakage thereof can be suppressed.

In an aspect of the present teachings, the three-dimensional additive manufacturing method may be either a powder bed fusion method or a directed energy deposition method.

In such a configuration, the powder bed fusion method can be selected when shape dimensional accuracy of a modeled object is important, and the directed energy deposition method can be selected when a size of the modeled object or production speed is important.

In an aspect of the present teachings, the additively manufactured object after performing the aging treatment may have a tensile strength of 950 MPa or more, a yield stress of 700 MPa or more, an elongation at fracture of 23% or more, and a reduction of area of 50% or more.

In such a configuration, by finishing the additively manufactured object, a high-strength component with strength and hydrogen embrittlement resistance equivalent to those of a conventional steel material (e.g., wrought bar material) can be obtained.

In an aspect of the present teachings, after performing the aging treatment, the additively manufactured object after a hydrogen charge at 270° C. for 200 hours under hydrogen atmosphere of 100 MPa may have an elongation at fracture of 0.8 times or more and a reduction of area of 0.5 times or more compared to the additively manufactured object before the hydrogen charge.

In such a configuration, hydrogen brittle fracture or delayed fracture is unlikely to occur even when the high-strength component is used in a hydrogen-intrusive environment.

In an aspect of the present teachings, the additively manufactured object may have a through hole penetrating in an axial direction thereof, and may have a cylindrical shape in which a plurality of parts being concentric and each having different diameters is connected along the axial direction.

In an aspect of the present teachings, the high-strength component may be a pipe connector configured to connect two pipes, and the finishing may include forming a threaded portion in each of two parts being spaced apart in the axial direction.

Hereinbelow, a method of manufacturing high-strength hydrogen pipe component disclosed herein (hereinafter referred to as the “manufacturing method”) will be described with reference to the drawings. The manufacturing method comprises an additively manufactured object modeling process, solution heat treatment process, aging treatment process, and a high-strength hydrogen pipe component manufacturing process. The high-strength hydrogen pipe component manufactured in the following description is an example, and this manufacturing method can be used to manufacture components having other shapes or used for other purposes as needed.

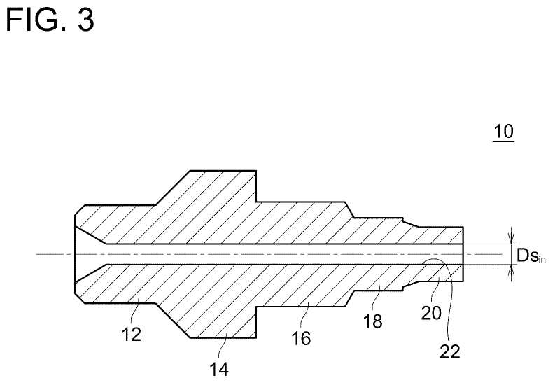

First, an additively manufactured object 10 modeled by this manufacturing method and a high-strength component 30 to be manufactured will be described. In this manufacturing method, a pipe connector 30 shown in FIG. 3 is manufactured as the high-strength component 30. The pipe connector 30 is used to connect pipes that distribute water or oil to each other.

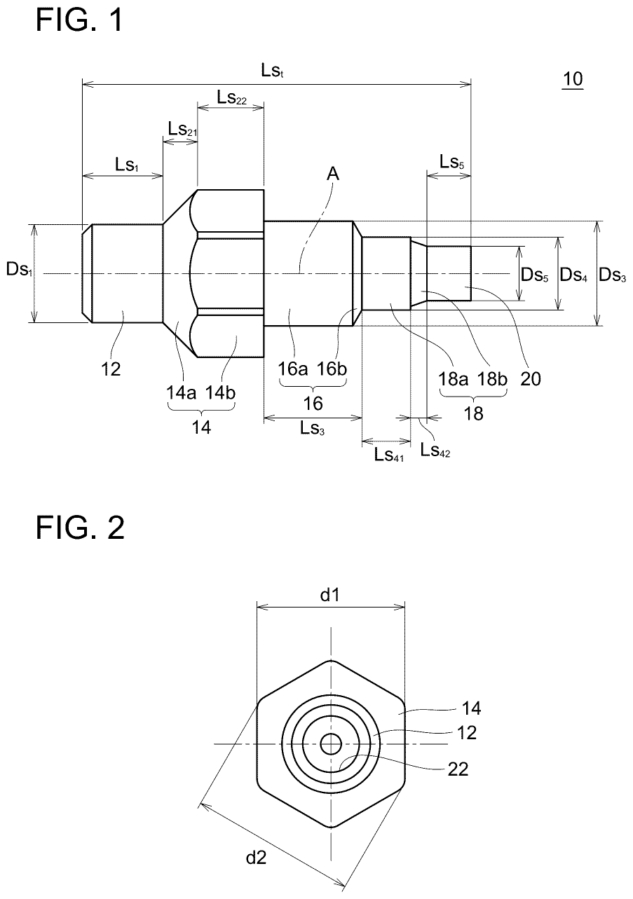

As shown in FIG. 1, the additively manufactured object 10 modeled by the present manufacturing method comprises a first portion 12, a second portion 14, a third portion 16, a fourth portion 18, and a fifth portion 20. The portions 12 to 20 are concentrically connected. A length Lsₜ (total length) of the additively manufactured object 10 in a direction along an axis A of the additively manufactured object 10 (hereinafter “axial direction”) is 49.9 mm. For convenience of explanation, the left side of the drawing will be referred to as “upper” and the right side of the drawing will be referred to as “lower” in the following description.

The first portion 12 has a cylindrical shape with a diameter Ds₁ of 12.6 mm. A length Ls₁ of the first portion 12 in the axial direction is 10.35 mm.

The second portion 14 is connected to a lower end of the first portion 12. The second portion 14 comprises an inclined portion 14a and a body 14b. The inclined portion 14a has a conical shape with a downwardly expanding diameter and is connected to the lower end of the first portion 12. The inclined portion 14a is inclined at 45 degrees relative to the axis A. A length Ls₂₁ of the inclined portion 14a in the axial direction is 4.45 mm. A diameter of an upper end of the inclined portion 14a is substantially equal to the diameter of the first portion 12. The body 14b has a regular hexagonal prismatic shape and is connected to a lower end of the inclined portion 14a. A length Ls₂₂ of the body 14b in the axial direction is 8.5 mm. Further, as shown in FIG. 2, when the additively manufactured object 10 is viewed from above, a length d1 between two opposing sides of the hexagon constituting the body 14b is 19 mm, and a length d2 between two opposing vertices across the axis center is 21.5 mm.

The third portion 16 is connected to a lower end of the second portion 14. The third portion 16 comprises a body 16a and an inclined portion 16b. The body 16a has a cylindrical shape and is connected to the lower end of the second portion 14 (body 14b). A diameter Ds₃ of the body 16a is 13.45 mm. The inclined portion 16b has a conical shape with a downwardly contracting diameter and is connected to a lower end of the body 16a. The inclined portion 16b is inclined at 60 degrees relative to the axis A. A length Ls₃ of the entire third portion 16 in the axial direction is 12.6 mm.

The fourth portion 18 is connected to a lower end of the third portion 16. The fourth portion 18 comprises a body 18a and an inclined portion 18b. The body 18a has a cylindrical shape and is connected to the lower end of the third portion 16 (inclined portion 16b). A diameter Ds₄ of the body 18a is 9.357 mm. The diameter of the body 18a is approximately equal to a diameter of the lower end of the inclined portion 16b of the third portion 16. A length Ls₄₁ of the body 18a in the axial direction is 6.208 mm. The inclined portion 18b has a conical shape with a downwardly contracting diameter and is connected to a lower end of the body 18a. A diameter of an upper end of the inclined portion 18b is slightly smaller than the diameter of the body 18a. The inclined portion 18b is inclined at 19 degrees relative to the axis A. A length Ls₄₂ of the inclined portion 18b in the axial direction is 2.092 mm.

The fifth portion 20 is connected to a lower end of the fourth portion 18. The fifth portion 20 has a cylindrical shape with a diameter Ds₅ of 6.985 mm. The diameter of the fifth portion 20 is approximately equal to the diameter of the lower end of the inclined portion 18b of the fourth portion 18. A length Ls₅ of the fifth portion 20 in the axial direction is 5.65 mm. As is clear from the above description, the diameters Ds₁, Ds₃, Ds₄, and Ds₅ of the first portion 12, third portion 16, fourth portion 18, and fifth portion 20, respectively, are different from each other, and further, the axial lengths Ls₁, Ls₂ (=Ls₂₁+Ls₂₂), Ls₃, Ls₄ (=Ls₄₁+Ls₄₂), and Ls₅ are also different from each other.

As shown in FIG. 3, the portions 12 to 20 each have a through hole 22 that penetrates through the portions 12 to 20 in the axial direction. The through hole 22 has a circular shape in its top view (cross-section perpendicular to the axis). The through hole 22 extends upward from a lower end of the fifth portion 20 with a uniform diameter Dsᵢₙ (2.65 mm), and gradually expands in diameter from the middle of the first portion 12. An expanded portion of the through hole 22 is inclined at 30 degrees relative to the axis A. A diameter of the through hole 22 at an upper end of the first portion 12 is 7.28 mm.

The additively manufactured object 10 has a volume density of at least 99.9%. The volume density is, for example, 99.92% or more, or for example 99.93% or more, or for example 99.94% or more, or for example 99.95% or more, or for example 99.96% or more, or for example 99.97% or more, or for example 99.98% or more, or for example 99.99% or more.

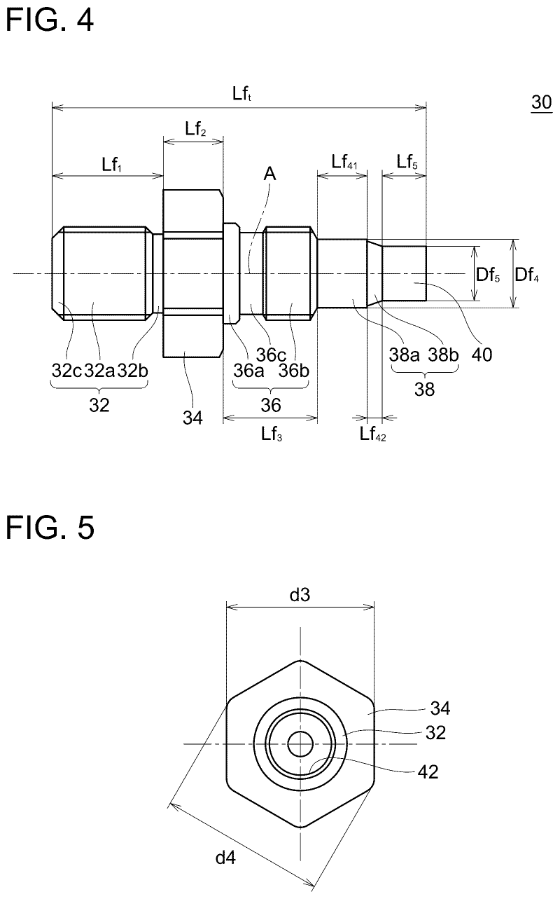

Next, the high-strength component (i.e., pipe connector 30) manufactured by this manufacturing method will be described. As shown in FIG. 4, the pipe connector 30 comprises a first portion 32, a second portion 34, a third portion 36, a fourth portion 38, and a fifth portion 40. The portions 32 to 40 are concentrically connected. A length Lfₜ (total length) of the pipe connector 30 in the axial direction is 48.1 mm.

The first portion 32 has a cylindrical shape. The first portion 32 has a threaded portion 32a and a constricted portion 32b connected to a lower end of the threaded portion 32a. An external thread is formed around the threaded portion 32a. An effective depth of the threaded portion 32a is 12 mm. A chamfered portion 32c is formed at an upper end of the threaded portion 32a. The constricted portion 32b has a smaller diameter than the threaded portion 32a. A length Lf₁ (corresponding to Ls₁+Ls₂₁) of the first portion 32 in the axial direction is 14.3 mm.

The second portion 34 is connected to a lower end of the first portion 32. The second portion 34 has a regular hexagonal prismatic shape. A length Lf₂ (corresponding to Ls₂₂) of the second portion 34 in the axial direction is 7.7 mm. As shown in FIG. 5, when the pipe connector 30 is viewed from above, a length d3 between two opposing sides of the hexagon constituting the second portion 34 is 19 mm, and a length d4 between two opposing vertices across the axis center is 21.5 mm.

The third portion 36 is connected to a lower end of the second portion 34. The third portion 36 has a base 36a, a threaded portion 36b, and a constricted portion 36c connecting the base 36a and threaded portion 36b. The base 36a is connected to the lower end of the second portion 34. A length of the base 36a in the axial direction is 2.1 mm. The threaded portion 36b is connected to a lower end of base 36a via the constricted portion 36c. An external thread is formed around the threaded portion 36b. An effective depth of the threaded portion 36b is 7 mm. The base 36a, threaded portion 36b, and constricted portion 36c are cylindrical in shape, and a diameter of the constricted portion 36c is smaller than diameters of the base 36a and threaded portion 36b. A length Lf₃ (corresponding to Ls₃) of the entire third portion 36 in the axial direction is 12.1 mm.

The fourth portion 38 is connected to a lower end of the third portion 36. The fourth portion 38 comprises a body 38a and an inclined portion 38b. The body 38a has a cylindrical shape and is connected to the lower end of the third portion 36 (threaded portion 36b). A diameter Df₄ (corresponding to Ds₄) of the body 38a is 8.79 mm. A length Lf₄₁ (corresponding to Ls₄₁) of body 38a in the axial direction is 6.4 mm. The inclined portion 38b has a conical shape with a downwardly contracting diameter and is connected to a lower end of the body 38a. A diameter of an upper end of the inclined portion 38b is slightly smaller than the diameter of the body 38a. The inclined portion 38b is inclined at 19 degrees relative to the axis A. A length Lf₄₂ (corresponding to Ls₄₂) of the inclined portion 38b in the axial direction is 1.95 mm.

The fifth portion 40 is connected to a lower end of the fourth portion 38. The fifth portion 40 has a cylindrical shape with a diameter Df₅ (corresponding to Ds₅) of 6.4 mm. The diameter of the fifth portion 40 is approximately equal to the diameter of the lower end of the inclined portion 38b of the fourth portion 38. A length Lf₅ (corresponding to Ls₅) of the fifth portion 40 in the axial direction is 5.65 mm. It is clear from the above that the dimensions of the additively manufactured object 10 (Ls, Ds, d1, d2) are designed slightly larger than the dimensions of the pipe connector 30 (Lf, Df, d3, d4). However, the dimensions (d1, d2) of the body 14b of the second portion 14 of the additively manufactured object 10 are set to be same as the dimensions (d3, d4) of the second portion 34 of the pipe connector 30, because dimensional accuracy is not required. That is, a final shape is formed at the stage of forming the additively manufactured object 10.

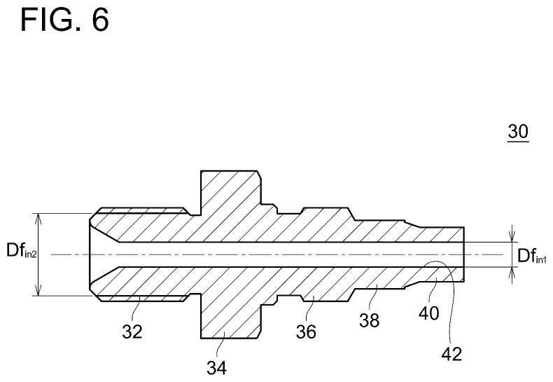

As shown in FIG. 6, the portions 32 to 40 each have a through hole 42 that penetrates through the portions 32 to 40 in the axial direction. The through hole 42 has a circular shape in its top view. The through hole 42 extends upward from a lower end of the fifth portion 40 with a uniform diameter Dfᵢₙ₁ (3.2 mm) (>Dsᵢₙ=2.65 mm) and gradually expands in diameter from the middle of the first portion 32. The expanded portion of the through hole 42 is inclined at 30 degrees relative to the axis A. A diameter Dfᵢₙ₂ of the through hole 42 at position 0.9 mm below an upper end of the first portion 32 (i.e., an upper end of the external thread of the threaded portion 32a) is 6.5 mm.

In this manufacturing method, after modeling the additively manufactured object 10 shown in FIG. 1, the solution heat treatment and the aging treatment are performed on the additively manufactured object 10, followed by finishing the additively manufactured object 10 to manufacture the pipe connector 30 shown in FIG. 4. Hereinbelow, the manufacturing method will be described in detail.

### (Additively Manufactured Object Modeling Process)

First, an additively manufactured object 10 is modeled using metal powder by a three-dimensional additive manufacturing method carried out by a 3D metal printer. The metal powder used for this modeling has a composition composed of the following by weight percentage (wt %): C: 0.010% to 0.025%, Si: 0.15% or less, Mn: 0.15% or less, P: 0.01% or less, S: 0.01% or less, Ni: 24% to 27%, Cr: 13.5% to 16%, Mo: 1% to 1.5%, V: 0.1% to 0.5%, Al: 0.35% or less, Ti: 1.90% to 2.35%, B: 0.0006% to 0.0020%, and balance consisting of Fe and unavoidable impurities.

### C: 0.010% to 0.025%

If the content of C exceeds 0.025%, in the three-dimensional additive manufacturing, when a molten layer solidifies and when a layer layered below the molten layer is re-heated by the molten layer, segregation occurs at grain boundaries of the additively manufactured object, and the ductility and toughness of the additively manufactured object could be reduced, and microcracks along the grain boundaries are more likely to occur. On the other hand, if C is reduced to zero, it leads to coarsening of crystal grains in the solution heat treatment and the aging treatment, resulting in a decrease in elongation at fracture and reduction of area (drawing). For these reasons and considering an amount that can be reduced in general industry, including refining costs, a lower limit is set at 0.010%. When the content of C is in the above range, C preferentially precipitates as TiC on the high temperature side during solidification of the molten layer, and this functions as a pin stop for grain growth.

### Si: 0.15% or Less

Si is an element that is used as a deoxidant and improves the strength of additively manufactured objects by solid solution strengthening. On the other hand, in the three-dimensional additive manufacturing, Si compounds with Fe, Ni, Ti, and Mo to precipitate low-melting eutectic compounds (Laves phase) at the grain boundaries when the molten layer solidifies and also when the layer layered below the molten layer is re-heated by the molten layer, by which liquefaction cracking or loss in ductility, that is, microcracking occurs along the grain boundaries. Due to this, Si content is reduced to the extent that it can be reduced in consideration of general industry, including refining costs, and an upper limit is set at 0.15%.

### Mn: 0.15% or Less

Mn is an element used as a deoxidant, and is also used for being solid-soluble in austenite to stabilize it and ensuring mechanical strength and toughness. On the other hand, if Mn content exceeds 0.15%, it tends to promote microcracks at the grain boundary in three-dimensional additive manufacturing, thus the Mn content is reduced to the extent possible in consideration of general industry, including refining costs, and an upper limit is set at 0.15%.

### P: 0.01% or Less

P is a low-melting point inclusion, and even a very small amount of P promotes microcracks at grain boundaries in three-dimensional additive manufacturing, so it is desirable to reduce P as much as possible. On the other hand, since excessive refining leads to increased costs, P content is reduced to the extent possible in consideration of general industry, and the P content is set to 0.01% or less.

### S: 0.01% or Less

S is a low-melting inclusion, and even a very small amount of S promotes microcracks at grain boundaries in three-dimensional additive manufacturing, so it is desirable to reduce S as much as possible. On the other hand, since excessive refining leads to increased costs, S content is reduced to the extent possible in consideration of general industry, and the S content is set to 0.01% or less.

### Ni: 24% to 27%

Ni is a key element for stabilizing austenite and providing excellent hydrogen embrittlement resistance, and must be added in sufficient amount to ensure an austenite stabilization index of nickel equivalent (Hirayama formula) of 28.5 or more. On the other hand, excessive Ni content also leads to increased costs and reduced recyclability. Considering these factors, the Ni content is set at 24% to 27%.

### Cr: 13.5% to 16%

Cr is a key element for improving corrosion resistance and providing excellent hydrogen embrittlement resistance. On the other hand, excessive Cr content leads to increased costs, thus the Cr content is set at 13.5% to 16%.

### Mo: 1% to 1.5%

Mo is an element that provides solid solution strengthening property and excellent hydrogen embrittlement resistance to austenite. On the other hand, excessive Mo content leads to increased costs, thus the Mo content is set to 1% to 1.5%.

### V: 0.10% to 0.50%

V is an element that preferentially precipitates as carbides at high temperatures during solidification and contributes to the prevention of crystal grain coarsening. On the other hand, excessive V content leads to increased costs, thus the V content is set to 0.10% to 0.50%.

### Al: 0.35% or Less

Al is an element that is used as a deoxidant and precipitates the γ′ phase (gamma prime phase, Ni₃ (Al, Ti)) during the aging treatment, resulting in age hardening and strength increase. The γ′ phase is stabilized with lower Ti/Al ratio, that is, with a higher Al content, however, at the same time, a heat treatment time required for the age hardening becomes longer. As such, the Al content is set to 0.35% or less to industrially achieve peak hardness after 3 to 20 hours.

### Ti: 1.90% to 2.35%

Ti is an element that precipitates γ′ phase (gamma prime phase, Ni₃ (Al, Ti)) during the aging treatment, resulting in age hardening and strength increase. In addition, this element preferentially precipitates as carbides at high temperatures during solidification, and contributes to the prevention of crystal grain coarsening. On the other hand, excessive Ti content leads to increased costs, thus the Ti content is set to 1.90% to 2.35%.

### B: 0.0006% to 0.0020%

B is an element that increases the strength of grain boundaries in conventional wrought materials, i.e., materials that have undergone casting and hot rolling, and improves the elongation at fracture and reduction of area value at room temperature, and creep strength at high temperatures. On the other hand, in three-dimensional additive manufacturing, when the molten layer solidifies and when the layer layered below the molten layer is re-heated by the molten layer, it compounds with other alloying elements to precipitate low-melting eutectic compounds at the grain boundaries, resulting in liquefaction cracking, that is, microcracks along the grain boundaries. Thus, it is desirable to reduce the B content as much as possible without sacrificing the elongation at fracture and reduction of area value at a room temperature, so the B content is set to 0.0006% to 0.0020%.

The above metal powder has a composition where the nickel equivalent Ni_{eq} (Hirayama formula), defined by the following formula, is 28.5 or more:

Ni_{eq}=12.6×[C %]+0.35×[Si %]+1.05×[Mn %]+[Ni %]+0.65×[Cr %]+0.98×[Mo %]

By using metal powder with the above nickel equivalent, excellent hydrogen embrittlement resistance as well as high strength can be given to the manufactured high-strength hydrogen pipe component 30μ. Further, the particle size of the metal powder is not particularly limited, however, for example, the particle size may be between 10 μm and 100 μm. The use of metal powder having such a particle size can contribute to improving a volume density of the high-strength hydrogen pipe component to be modeled by three-dimensional additive manufacturing.

In this method, the three-dimensional additive manufacturing method is selected from either Powder Bed Fusion (PBF) method or Directed Energy Deposition (DED) method. In PBF, the metal powder spread on a modeling plate is irradiated with a laser or electron beam. This melts the metal powder, and molten metal powder solidifies and combines with each other to form a manufactured object. When one layer of modeling is completed, metal powder for modeling the next layer is spread again on the modeling plate. By repeating this process in a layering direction, the additively manufactured object 10 shown in FIG. 1 is modeled.

In DED, a laser is irradiated onto a modeling plate and metal powder is injected onto the irradiated area. Due to this, the metal powder melts in the irradiated area. In DED, the metal powder is repeatedly melted and solidified by injecting the metal powder while moving a laser irradiation point on the modeling plate. By repeating this process in the layering direction, the additively manufactured object 10 shown in FIG. 1 is modeled.

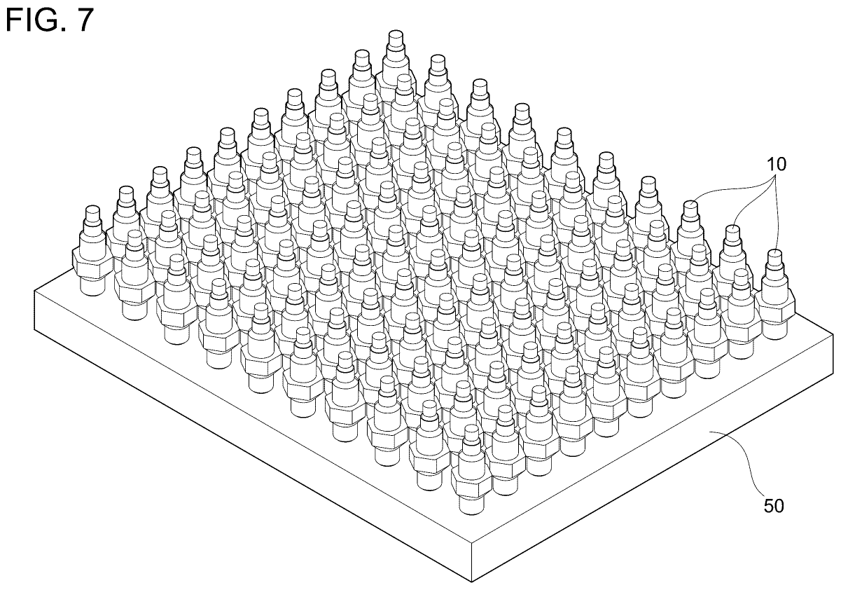

In any of the above methods, a layering pitch (thickness of one layer) may be set to 10 to 100 μm, for example. However, the layering pitch is not limited to this, and may be adjusted according to a particle size of the metal powder that is used. Further, in this manufacturing method, as shown in FIG. 7, a plurality of additively manufactured objects 10 is modeled on the modeling plate 50. This can reduce modeling cost. As is clear from FIG. 7, the additively manufactured objects 10 are modeled in order from the first portion 12 side toward the fifth portion 20 side.

### (Solution Heat Treatment Process)

Next, the solution heat treatment is performed on the additively manufactured object 10. The solution heat treatment is performed primarily for the purpose of removing residual stress in the additively manufactured object 10 that was generated in modeling, or for solid-solving the compounds that precipitated during modeling. In the solution heat treatment, the additively manufactured object 10 is kept at 885 to 915° C. or 965 to 995° C. for 10 minutes to 2 hours, and then rapidly cooled to room temperature. The kept time in the above temperature range may be adjusted according to the required purpose, such as when grain refinement or complete solid solution of the manufactured object is desired.

### (Aging Treatment Process)

Next, aging treatment is performed on the additively manufactured object 10. The aging treatment is performed to improve hardness of the additively manufactured object 10 by precipitating an intermetallic compound primarily called the γ′ phase (gamma prime phase, Ni₃ (Al, Ti)). In the aging treatment, the additively manufactured object 10 is kept at 680 to 700° C. for 16 hours or more, and then air-cooled to room temperature.

### (Finishing Process)

Next, finishing is performed on the additively manufactured object 10. The finishing includes, for example, a removal process such as cutting and grinding, and surface treatment for modification of a component surface. In this manufacturing method, the pipe connector 30 shown in FIG. 4 is manufactured from the additively manufactured object 10 by performing the finishing on a range of the additively manufactured object 10 along the axial direction excluding side surfaces of the hexagonal prismatic body 14b.

As described above, in this manufacturing method, the pipe connector 30 is manufactured by finishing the additively manufactured object 10, which is modeled by the three-dimensional additive manufacturing method. Due to this, by modeling the additively manufactured object 10 that approximates the shape of the pipe connector 30 to be manufactured by the three-dimensional additive manufacturing method, a machining allowance for the finishing can be reduced. Specifically, in this manufacturing method, a cutting allowance for the finishing can be reduced to about 1 mm. As such, as compared to a conventional case of manufacturing a target component from steel (e.g., wrought bar material), the finishing process such as cutting can dramatically be reduced.

Further, in this manufacturing method, even when a material with a high nickel equivalent, which is difficult to work, is used, an adverse effect on workability of such material is reduced. Due to this, the effect on processes such as cutting, which is highly dependent on the skill of the operator, can be reduced, and precision of the resulting pipe connector 30 can be improved.

The aforementioned manufacturing method described the method for manufacturing the pipe connector 30. However, the art disclosed herein may be applied to manufacture of other components. Specifically, for example, it may be used in manufacturing metal components (bolts, nuts, etc.) used in a hydrogen-intrusive environment.

In the aforementioned manufacturing method, the solution heat treatment, the aging treatment, and the finishing were performed in this order on the modeled additively manufactured object 10 in sequence. As above, since the finishing is performed in a final process, it is easy to control the shape and surface roughness quality of the manufactured pipe connector 30. However, in this manufacturing method, for example, the solution heat treatment and the aging treatment may be performed in sequence after the finishing is performed on the modeled additively manufactured object 10. In this case, since the finishing is performed first on the additively manufactured object 10, the quality of a reference surface for the finishing can be controlled according to conditions of layer modeling. Also, for example, the solution heat treatment may be performed on the modeled additively manufactured object 10, and the finishing and the aging treatment may be performed thereafter in this order. In this case, since the finishing (cutting, surface treatment, etc.) is performed on the relatively soft additively manufactured object 10 after the solution heat treatment, workability in the finishing can be improved. As above, in this manufacturing method, the order of the processes may be interchangeable according to needs depending on the shape and the required quality of the component to be manufactured.

The following are specific examples embodying the art disclosed herein. However, the disclosure herein is not limited to the following specific examples.

### <Preparation of Modeled Objects for Volume Density Evaluation>

First, metal powder with composition A shown in Table 1 was prepared. A particle size of the metal powder ranged from 15 to 53 μm. Then, 10 mm square cubes were modeled for preliminary evaluation under several laser irradiation conditions in order to study a volume density of three-dimensional additively manufactured objects modeled by the powder bed fusion bonding method (PBF) using the metal powder. As a result, it was found that the volume density reached 99.9% or more when an energy density by laser irradiation was 60 J/mm³ or more. The volume density was measured by image analysis after mirror polishing Z-axis cross sections of the modeled objects for 3 minutes.

TABLE 1

| | Component (weight %) | | | | | | | | | | | | |
|---|---|---|---|---|---|---|---|---|---|---|---|---|---|
| Composition | C | Si | Mn | P | S | Ni | Cr | Mo | V | Al | Ti | B | Fe |
| A | 0.019 | 0.05 | 0.05 | 0.003 | 0.006 | 24.24 | 13.65 | 1.05 | 0.18 | 0.22 | 2.00 | 0.0020 | bal. |
| B | 0.41 | 0.16 | 1.16 | 0.005 | 0.005 | 24.28 | 13.61 | 1.04 | 0.18 | 0.15 | 2.10 | 0.0050 | bal. |

### Preparation of Test Pieces for Examples 1 to 3

(Additively Manufactured Object Modeling and Processing into SSRT Test Pieces)

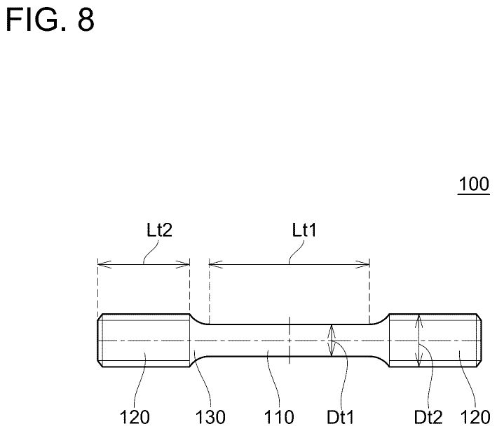

Using the same metal powder (composition A, particle size 15 to 53 m) that was used for the above modeled objects for evaluation, round bar with Φ18 and L80 being base material for SSRT test piece was modeled using the three-dimensional additive manufacturing method being the powder bed fusion bonding (PBF) method under the above laser irradiation conditions. The volume density of the Φ18×L80 round bar was 99.9% or more. Then, the solution heat treatment and the aging treatment as described in detail below were performed on the modeled object, which was then subjected to cutting finish and completed as SSRT test piece 100 shown in FIG. 8.

### (Solution Heat Treatment)

The solution heat treatment as specified in JIS G4311 was performed on the additively manufactured object being the Φ18×L80 round bar. Specifically, the solution heat treatment was performed on the additively manufactured object being the Φ18×L80 round bar by keeping it at 980° C. for 1 hour and thereafter rapidly cooling it to room temperature.

### (Aging Treatment)

After the solution heat treatment, the aging treatment was performed on the additively manufactured object being the Φ18×L80 round bar by keeping it at 690° C. for 20 hours and thereafter air-cooling it to room temperature. Prior to setting treatment temperature conditions, a comparison evaluation was performed on 10 mm square cubic samples 1 to 4, which were subjected to the three-dimensional additive manufacturing and solution heat treatment under the same conditions as those for the Φ18×L80 round bar, and respectively subjected to aging treatment at temperatures between 68° and 740° C. A soaking time in the aging treatment was standardized at 20 hours to obtain maximum hardness. The evaluation was performed at five locations in the cross section in the Z-axis layering direction of the cubic samples, using a Vickers hardness test of HV 10 kg, based on the presence/absence of microcracks (hereafter referred to as indentation cracks) occurring from the corners of the square indentations made on the test surface in the Vickers hardness test. The results are shown in Table 2. For the Vickers hardness in Table 2, “A” indicates a value at the center of the cross section in the Z-axis layering direction, and “B” to “E” indicate values near the four corners in the cross section in the Z-axis layering direction. The values of the portions that exhibited indentation cracks are underlined. An indentation crack frequency indicates the number of indentation cracks that occurred among the five locations A to E.

TABLE 2

| | Aging | Aging | | | | | | | | | | |
|---|---|---|---|---|---|---|---|---|---|---|---|---|
| | Treatment | Treatment | | | | | | | | | | Indentation |
| | Temprature | Time | HV | Vickers Hardness (HV) | | | | | | | | Crack |
| Sample | (°C) | (hour) | Load | A | B | C | D | E | Average | Maximum | Minimum | Frequency |
| 1 | 680 | 20 | HV10 | 353 | 349 | 348 | 360 | 357 | 353 | 360 | 348 | 0 |
| 2 | 700 | 20 | HV10 | 350 | 351 | 351 | 342 | 342 | 347 | 351 | 342 | 0 |
| 3 | 720 | 20 | HV10 | 354 | 351 | 357 | 363 | 351 | 355 | 363 | 351 | 2 |
| 4 | 740 | 20 | HV10 | 350 | 360 | 345 | 358 | 343 | 351 | 360 | 343 | 3 |

As shown in Table 2, the Vickers hardness of 343 to 363 HV was obtained for Samples 3 and 4 aged at 720° C. and 740° C., however, indentation cracks were observed. On the other hand, Samples 1 and 2 aged at 680° C. and 700° C. obtained high Vickers hardness (342 to 360 HV), and no indentation cracks were observed. That is, it was found that the aging treatment at 700° C. or lower suppressed embrittlement and produced high strength.

### (Cutting Finish)

After the aging treatment, the SSRT test piece 100 shown in FIG. 8 was prepared by cutting finish. As shown in FIG. 8, the SSRT test piece 100 has a shaft portion 110 and a fixed portion 120 provided at both ends of the shaft portion 110. Each fixed portion 120 is provided at its corresponding end of the shaft 110 via a transition portion 130. The shaft portion 110 has a cylindrical shape with a diameter Dt1 of about 6 mm and an axial length Lt1 of about 30 mm. Each transition portion 130 has a tapered shape and connects the shaft portion 110 and its corresponding fixed portion 120. Each fixed portion 120 has a cylindrical shape with a diameter Dt2 of about 18 mm and an axial length Lt2 of about 18 mm. The shaft portion 110, the fixed portions 120, and the transition portions 130 are finished with mirror polish. Further, the shaft portion 110 was cut-finished according to the following procedure. First, starting with a diameter of 7.0 mm, it was cut with a cut depth of 0.1 mm until the diameter became 6.2 mm. Next, from 6.2 mm, it was cut with a cut depth of 0.05 mm until the diameter became 6.1 mm. Then, it was further cut until the diameter was 6.07 mm. The remaining 70 m was polished off by emery paper and buffing. A mirror-finished portion was observed in its entire circumference with a 40× magnifying glass to confirm that there were no circumferential scratches. An axial runout at the shaft portion 110 and both fixed portions 120 was confirmed to be 0.05 mm or less.

The test pieces in Examples 2 and 3 were also prepared by the same procedure as in Example 1, using the same metal powder as in Example 1.

### Preparation of Test Pieces for Examples 4 to 6

For Examples 4 to 6, the SSRT test pieces 100 made from the additively manufactured objects produced by the same procedure as in Example 1 were subjected to the following forced hydrogen charge. First, the SSRT test pieces 100 were degreased with acetone prior to hydrogen charge in order to remove oil that may adhere and remain in the manufacturing process. Then, the SSRT test pieces 100 were hydrogen-charged by keeping them at 270° C. for 200 hours under hydrogen atmosphere of 100 MPa (1000 atm). After the hydrogen charge, the SSRT test pieces 100 were stored in liquid nitrogen to prevent hydrogen release. A hydrogen concentration of the test pieces after the hydrogen charge was 77 ppm.

### Preparation of Test Pieces for Comparative Examples 1 to 3

The test pieces in Comparative Examples 1 to 3 were prepared by the same procedure as in Example 1, except that a metal powder having composition B in Table 1 was used.

### Preparation of Test Pieces for Comparative Examples 4 to 6

For Comparative Examples 4 to 6, the SSRT test pieces 100 made from the additively manufactured objects produced by the same procedure as in Comparative Example 1 were subjected to the hydrogen-charge was performed under the same conditions as in Example 4.

### <Preparation of Test Pieces for Controls 1 to 3>

For Control 1, a commercially available wrought bar material (SUH660) was first machined into a shape similar to the SSRT sample 100 made from the additively manufactured object shown in FIG. 8. Then, the solution heat treatment and the aging treatment were performed on the machined wrought bar material. The solution heat treatment temperature was 980 to 990° C., and the aging treatment was performed at 720° C. for 16 hours, followed by air cooling to room temperature. The wrought bar material subjected to the aging treatment was used as the test piece for Control 1. The test pieces for Controls 2 and 3 were also prepared by the same procedure as the test piece for Control 1 using the same wrought bar material.

### <Preparation of Test Pieces for Controls 4 to 6>

For Controls 4 to 6, test pieces were produced from the wrought bar material that had been processed according to the same procedure as in Control 1 and hydrogen-charged under the same conditions as in Example 4.

### (SSRT Test)

Each test piece was subjected to a slow strain rate tensile test (Slow Strain Rate Technique, SSRT) at a crosshead speed of 1.5 m/sec (strain rate 5×10⁻⁵/sec) at room temperature and in atmospheric environment, and tensile strength, yield stress, elongation at fracture, and reduction of area were measured. Measurement results are shown in Table 3.

TABLE 3

| | | | Tensile | Yield | Elongation | Reduction | Vickers | Volume |
|---|---|---|---|---|---|---|---|---|
| | | Hydrogen | Strength | Stress | at Fracture | of Area | Hardness | Density |
| | Composition | Charge | (MPa) | (MPa) | (%) | (%) | (HV) | (%) |
| Example 1 | A | x | 1000 | 740 | 25 | 52 | 348-362 | 99.90- |
| Example 2 | A | x | 1000 | 740 | 26 | 56 | HV *1 | 99.97% |
| Example 3 | A | x | 1010 | 750 | 26 | 57 | | *2 |
| Example 4 | A | ∘ | 1010 | 750 | 23 | 33 | | |
| Example 5 | A | ∘ | 1010 | 750 | 23 | 29 | | |
| Example 6 | A | ∘ | 1010 | 750 | 22 | 33 | | |
| Comparative | B | x | 1020 | 750 | 19 | 24 | 306-329 | |
| Example 1 | | | | | | | HV *1 | |
| Comparative | B | x | 1020 | 750 | 15 | 20 | | |
| Example 2 | | | | | | | | |
| Comparative | B | x | 1040 | 760 | 19 | 24 | | |
| Example 3 | | | | | | | | |
| Comparative | B | ∘ | 980 | 750 | 10 | 14 | | |
| Example 4 | | | | | | | | |
| Comparative | B | ∘ | 1000 | 760 | 12 | 16 | | |
| Example 5 | | | | | | | | |
| Comparative | B | ∘ | 980 | 760 | — | — | | |
| Example 6 | | | | | | | | |
| Control 1 | — | x | 1060 | 760 | 26 | 52 | 307-351 | — |
| Control 2 | — | x | 1060 | 740 | 27 | 52 | HV *3 | |
| Control 3 | — | x | 1070 | 750 | 27 | 53 | | |
| Control 4 | — | ∘ | 1050 | 780 | 22 | 32 | | |
| Control 5 | — | ∘ | 1050 | 780 | 22 | 32 | | |
| Control 6 | — | ∘ | 1050 | 780 | — | — | | |

*1 Measurement data using 10 mm square cubes for preliminary evaluation.
*2 Image measurement value of the cross section in layering direction of 10 mm square cubes for preliminary evaluation. The test surfaces were polished for 3 minutes.
*3 Performance data for connector components made from the same material.

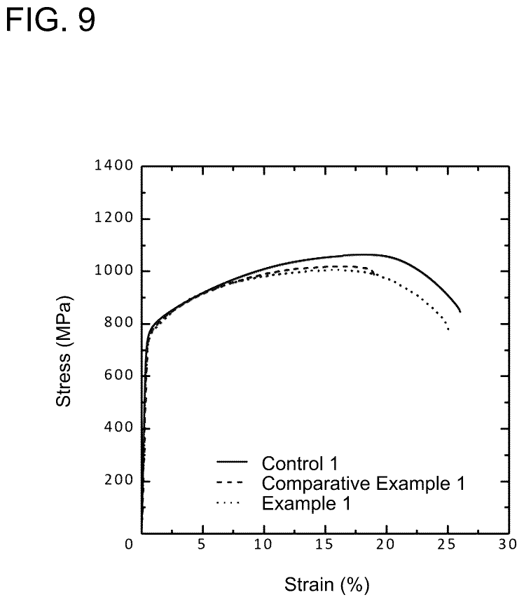

FIG. 9 shows stress-strain curves of the SSRT test results for the test pieces of Example 1, Comparative Example 1, and Control 1. That is, FIG. 9 shows the test results for each test piece before the hydrogen charge. As shown in Table 3 and FIG. 9, the results for tensile strength and yield stress were comparably similar for all test pieces. On the other hand, the elongation at fracture was 15 to 19% for the test pieces in the Comparative Examples, whereas on the other hand, prominently high values of 25 to 26% were exhibited for the test pieces in the Examples. These values are equivalent to the values (26 to 27%) of the test pieces machined from the conventional wrought bar material (Controls), indicating that the test pieces of Examples 1 to 3 have high ductility despite their high strength. Further, in regard to the reduction of area, the resulting values were remarkably high, ranging from 52 to 57% for the test pieces of Examples 1 to 3 as compared to 20 to 24% for the test pieces of Comparative Examples. These values are equivalent to the values (52 to 53%) of the test pieces machined from the conventional wrought bar material (Controls), indicating that the test pieces of Examples 1 to 3 have high ductility. This is considered to be due to the fact that microcracks in the test pieces of Examples 1 to 3 were reduced to a very low level by adjustments performed on metal powder composition and various post-modeling treatment conditions. Microcracks contribute to stress-induced crack initiation and propagation in SSRT tests. That is, the test pieces of the Examples with almost no microcracks exhibited high elongation at fracture and high reduction of area, because it was difficult for the cracks to initiate and propagate. Furthermore, by adjusting the composition of the metal powder in the test pieces of the Examples, low-melting eutectic compounds are less likely to precipitate at the grain boundaries. The eutectic compounds are very hard and brittle, and thus contribute to crack initiation and propagation in response to stress during the SSRT test. As such, it is considered that strength and ductility are improved in the case where metal powder with a composition that is difficult to precipitate such eutectic compounds is used.

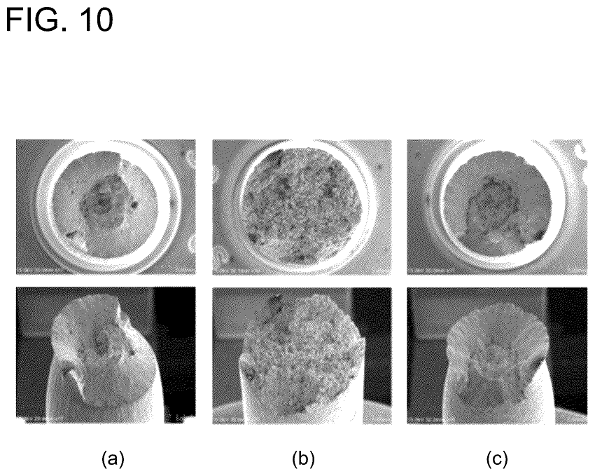

FIG. 10 is SEM images of fracture surfaces of the test pieces of Example 1, Comparative Example 1, and Control 1 after the SSRT test. FIG. 10(a) is the fracture surface of the test piece of Example 1, FIG. 10(b) is the fracture surface of the test piece of Comparative Example 1, and FIG. 10(c) is the fracture surface of the test piece of Control 1. The fracture surfaces of the test pieces of Example 1 and Control 1 were so-called cup-and-cone type, while the fracture surface of the test piece of Comparative Example 1 was perpendicular to a stress-acting direction (so-called vertical fracture).

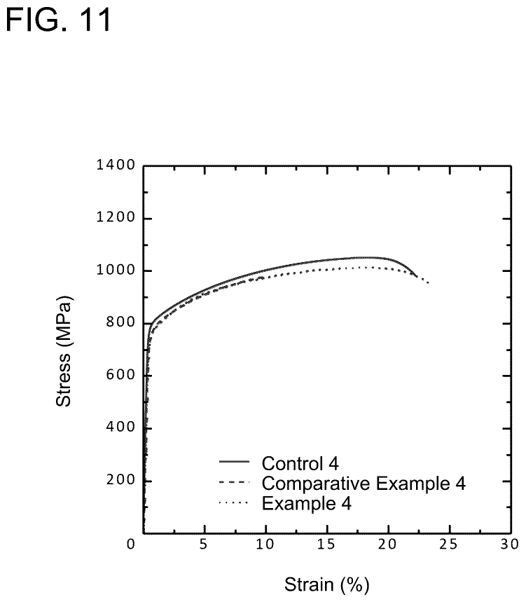

FIG. 11 shows stress-strain curves of the SSRT test results for the test pieces of Example 4, Comparative Example 4, and Control 4. That is, FIG. 11 shows the test results for each test piece after the hydrogen charge. As shown in Table 3 and FIG. 11, the results for tensile strength and yield stress were comparably similar for all test pieces. On the other hand, the elongation at fracture was 10 to 12% for the test pieces in the Comparative Examples, whereas on the other hand, prominently high values of 22 to 23% were exhibited for the test pieces in the Examples. These values are equivalent to the values (22%) of the test pieces machined from the conventional wrought bar material (Controls), indicating that the test pieces of the Examples have high ductility even after the hydrogen charge. Also, in regard to the reduction of area, the resulting values were remarkably high, ranging from 29 to 33% for the test pieces of Examples, as compared to 14 to 16% for the test pieces of Comparative Examples. These values are equivalent to the value (32%) of the test pieces machined from the conventional wrought bar material (Controls), indicating that the test pieces in the Examples have high ductility even after the hydrogen charge.

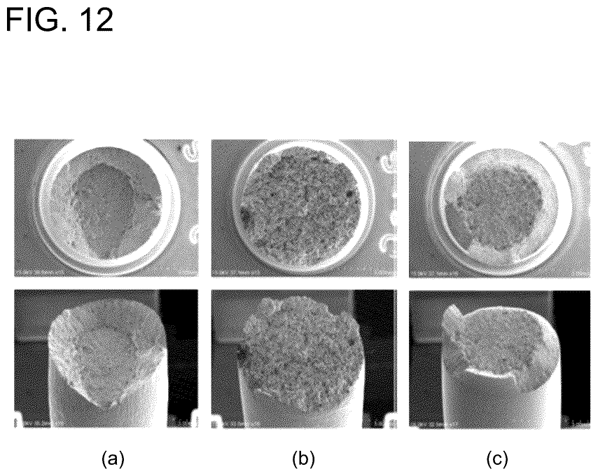

FIG. 12 is SEM images of fracture surfaces of the test pieces of Example 4, Comparative Example 4, and Control 4 after the SSRT test. FIG. 12(a) is the fracture surface of the test piece of Example 4, FIG. 12(b) is the fracture surface of the test piece of Comparative Example 4, and FIG. 12(c) is the fracture surface of the test piece of Control 4. Similar to the fracture surfaces before the hydrogen charge (FIG. 10), the fracture surfaces of the test pieces of Example 4 and Control 4 were cup-and-cone type, while the fracture surface of the test piece of Comparative Example 4 was perpendicular to the stress-acting direction.

A ratio of elongation at fracture (relative elongation at fracture) and a ratio of reduction of area (relative reduction of area) of each test piece before and after the hydrogen charge were compared between FIGS. 9 and 11. The relative elongation at fracture was 0.53 in the Comparative Examples, whereas it was 0.92 in the case of the Examples, which was significantly higher. Further, the relative reduction of area was 0.58 in the Comparative Examples, while it was 0.63 in the case of the Examples, which was higher. That is, it has been found that the Examples have superior hydrogen embrittlement resistance compared to the Comparative Examples. This result is comparable to the relative elongation at fracture (0.85) and relative reduction of area (0.62) of the test pieces in the Controls. These results may be attributed to the more acute propagation of cracks caused by microcracks in the hydrogen-charged test pieces. As mentioned above, the test pieces in the Examples have very few microcracks. Due to this, it is considered that the test pieces in the Examples exhibited a low degree of hydrogen embrittlement and high relative elongation at fracture and high relative reduction of area even after the hydrogen charge. Thus, it was confirmed that by adjusting the composition of the metal powder and the aging treatment conditions, etc., the three-dimensional additive manufacturing method can be used to obtain high-strength components with excellent hydrogen embrittlement resistance.

Compositions A and B shown in Table 1 both have compositions within the SUH660 composition range specified in JIS G4311. However, as is clear from the above description, it has been confirmed that adjusting the composition to a specific value within the aforementioned range achieves additively manufactured objects with high strength and excellent hydrogen embrittlement resistance.

While specific examples of the present disclosure have been described above in detail, these examples are merely illustrative and place no limitation on the scope of the patent claims. The technology described in the patent claims also encompasses various changes and modifications to the specific examples described above. The technical elements explained in the present description or drawings provide technical utility either independently or through various combinations. The present disclosure is not limited to the combinations described at the time the claims are filed. Further, the purpose of the examples illustrated by the present description or drawings is to satisfy multiple objectives simultaneously, and satisfying any one of those objectives gives technical utility to the present disclosure.

### REFERENCE SIGNS LIST

10: additively manufactured object, 12: first portion, 14: second portion, 14a: inclined portion, 14b: body, 16: third portion, 16a: body, 16b: inclined portion, 18: fourth portion, 18a: body, 18b: inclined portion, 20: fifth portion, 22: through hole, 30: pipe connector, 32: first portion, 32a: threaded portion, 32b: constricted portion, 32c: chamfered portion, 34: second portion, 36: third portion, 36a: base, 36b: threaded portion, 36c: constricted portion, 38: fourth portion, 38a: body, 38b: inclined portion, 40: fifth portion, 42: through hole, 50: modeling plate

1. A manufacturing method of a high-strength component having excellent hydrogen embrittlement resistance, the method comprising:
modeling an additively manufactured object having a volume density of 99.9% or more by a three-dimensional additive manufacturing method using a laser or an electron beam having an energy density of 60 J/mm3 or more using a metal powder having a composition containing, by weight percentage (wt %):
C: 0.010% to 0.025%,
Si: 0.15% or less,
Mn: 0.15% or less,
P: 0.01% or less,
S: 0.01% or less,
Ni: 24% to 27%,
Cr: 13.5% to 16%,
Mo: 1% to 1.5%,
V: 0.10% to 0.50%,
Al: 0.35% or less,
Ti: 1.90% to 2.35%,
B: 0.0006% to 0.0020%, and
the balance consisting of Fe and unavoidable impurities; and
manufacturing the high-strength component by finishing the additively manufactured object.

2. The manufacturing method according to claim 1, further comprising:
performing a solution heat treatment in which the additively manufactured object is kept at 885 to 915° C. or 965 to 995° C. for 10 minutes to 2 hours, and then rapidly cooled to room temperature; and
performing an aging treatment in which the additively manufactured object is kept at 680 to 700° C. for 16 hours or more, and then air-cooled to room temperature, after performing the solution heat treatment.

3. The manufacturing method according to claim 1, wherein
the three-dimensional additive manufacturing method is either a powder bed fusion method or a directed energy deposition method.

4. The manufacturing method according to claim 2, wherein
the additively manufactured object after performing the aging treatment has a tensile strength of 950 MPa or more, a yield stress of 700 MPa or more, an elongation at fracture of 23% or more, and a reduction of area of 50% or more.

5. The manufacturing method according to claim 4, wherein
after performing the aging treatment, the additively manufactured object after a hydrogen charge at 270° C. for 200 hours under hydrogen atmosphere of 100 MPa has an elongation at fracture of 0.8 times or more and a reduction of area of 0.5 times or more compared to the additively manufactured object before the hydrogen charge.

6. The manufacturing method according to claim 1, wherein
the additively manufactured object has a through hole penetrating in an axial direction thereof, and has a cylindrical shape in which a plurality of parts being concentric and each having different diameters is connected along the axial direction.

7. The manufacturing method according to claim 6, wherein
the high-strength component is a pipe connector configured to connect two pipes, and
the finishing includes forming a threaded portion in each of two parts being spaced apart in the axial direction.
